(19) United States
(12) Patent Application Publication
(10) Pub. No.: US 2009/0043694 A1
(43) Pub. Date: Feb. 12, 2009

(54) SYSTEM AND METHOD FOR INTEGATING DIGITAL RIGHTS MANAGEMENT INFORMATION AND PAYMENT INFORMATION

(76) Inventors: Hugo Olliphant, San Francisco, CA (US); Vishwanath Shastry, Palo Alto, CA (US); Matthew Mengerink, San Jose, CA (US); Harvey Grasty, Los Gatos, CA (US)

Correspondence Address: SCHWEGMAN, LUNDBERG & WOESSNER/EBAY, P.O. BOX 2938, MINNEAPOLIS, MN, 55402, US

(21) Appl. No.: 11/837,001

(22) Filed: Aug. 10, 2007

(51) Int. Cl. G06Q 10/00; G06Q 20/00

(52) U.S. Cl. 705/39; 705/1

(57) ABSTRACT

One embodiment provides a system of distributing digital content from a first party to a second party over a network. The system includes an interface to receive by the second party from the first party a digital content package including a digital content and its header. The header provides Digital Rights Management (DRM) information and payment information for the digital content. The system also includes a payment module to receive a payment from the second party based on the received payment information. The system further includes an authorization module, after receiving the payment, to allow the second party to play the digital content under restrictions described in the received DRM. In some embodiments, the system may also include a preview module to allow the second party to preview the digital content for a predetermined number of times or for a predetermined length of time.

### TECHNICAL FIELD

The present application relates generally to a system and method for distributing digital content and more specifically to a system and method for integrating Digital Rights Management (DRM) information and payment information for the digital content.

### BACKGROUND

With the development of computer and network related technologies, many users choose to purchase and/or distribute digital content (e.g., digital music, digital videos, digital documents, and digital photos) over networks. In many situations, it is desirable to facilitate and simplify the process of the purchase and/or distribution of the digital content over networks.

### BRIEF DESCRIPTION OF THE DRAWINGS

The present application is illustrated by way of example and not limitation in the figures of the accompanying drawings, in which like references indicate similar elements and in which:

FIG. 1 is an overview diagram showing a network system configured to distribute digital content and to transmit payment thereof over a network according to an example embodiment of the application;

FIG. 2 is a diagram showing an interface for a buyer to receive the digital content according to an example embodiment;

FIG. 3 is a diagram showing an interface for a buyer to receive the digital content according to another example embodiment;

FIG. 4 is a diagram showing a data structure of a distributed digital content package according to an example embodiment;

FIG. 5 is a block diagram showing a buyer system according to an example embodiment;

FIG. 6 is a block diagram showing a payment system according to an example embodiment;

FIG. 7 is a high level flowchart showing a method of distributing the digital content from a first buyer system to a second buyer system via a peer-to-peer network according to an example embodiment; and

FIG. 8 is a block diagram showing a machine in the example form of a computer system, within which a set of sequence of instructions for causing the machine to perform any one of the methodologies discussed herein may be executed.

### DETAILED DESCRIPTION

A system and method for integrating Digital Rights Management (DRM) information and payment information for digital content are described. In the following detailed description of the embodiments, reference is made to the accompanying drawings which form a part hereof, and in which is shown by way of illustration specific embodiments in which the application may be practiced. The following detailed description is not to be taken in a limiting sense, and the scope of the present inventions is defined only by the appended claims.

The term “DRM” used in the following description denotes “Digital Rights Management” attempting to control access to or usage of digital content (such as software, music, movies), which can otherwise be copied with very little cost or effort. Beyond restrictions under copyright law, most DRM schemes attempt to impose additional restrictions on the digital content at the discretion of the digital content's publisher, in which DRM information of the digital content can be used to convey the restriction information of the digital content to users or potential users.

The term “peer-to-peer network” denotes a computer network that relies primarily on the computing power and bandwidth of the participants in the network rather than concentrates in a relatively low number of servers. An important goal of a peer-to-peer network is that all clients provide resources, including bandwidth, storage space, and computing power.

Network System

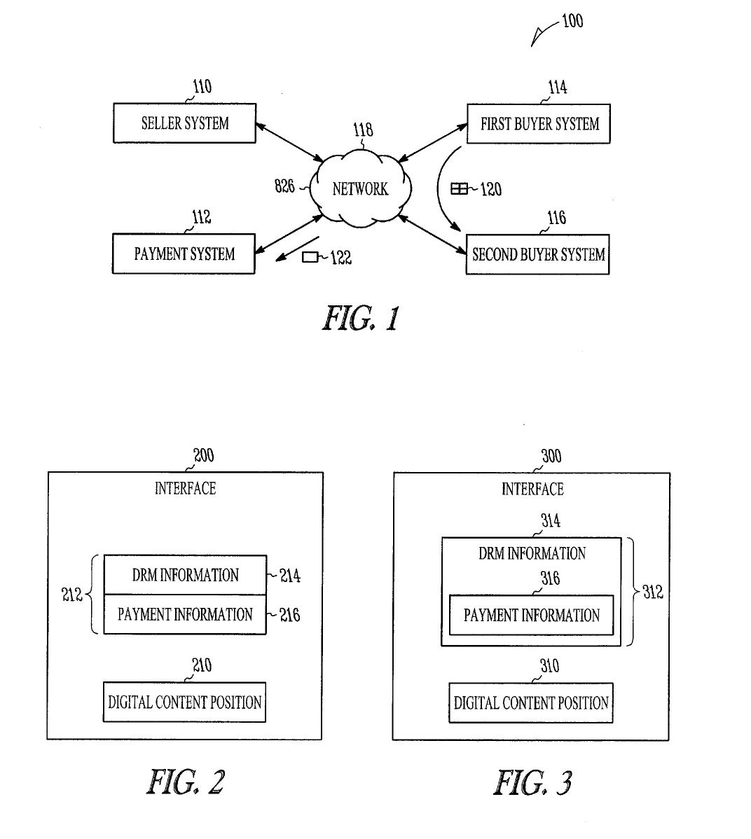

FIG. 1 illustrates an overview diagram showing a network system 100 configured to distribute digital content and to transmit payment thereof over a network according to an example embodiment of the application. The network system 100 includes a seller system 110, a payment system 112, a first buyer system 114, and a second buyer system 116, all of which are in communication with each other via a network 118. The seller system (or seller server) 110 can distribute digital content in a digital content package 120 to a buyer system (or a buyer client), e.g., the first buyer system 114, via the network 118. The first buyer system 114 can also distribute the received digital content package 120 to another buyer system, e.g., the second buyer system 116, via the network 118. For example, a buyer may send one or more tracks of received music to another potential buyer via the network 118.

In some embodiments, a peer-to-peer network can be used to distribute the digital content package 120 from a buyer system (e.g., the first buyer system 114) to another buyer system (e.g., the second buyer system 116). The peer-to-peer network can be, for example, a centralized peer-to-peer network, a decentralized peer-to-peer network, a structured peer-to-peer network, an unstructured peer-to-peer network, and/or a hybrid peer-to-peer network. The peer-to-peer network can be either a First Generation peer-to-peer network or a Second Generation peer-to-peer network.

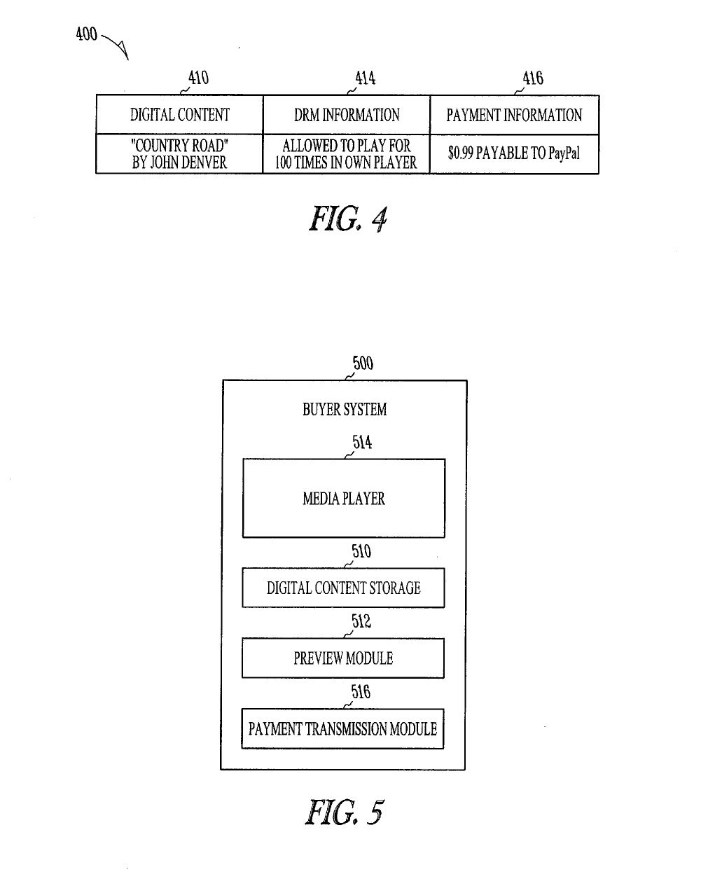

The network system 100 provides an interface, as shown in detail in FIGS. 2 and 3, for a buyer to receive the digital content package 120 distributed from either the seller system 110 or another buyer. The distributed digital content package 120, with a data structure shown in detail in FIG. 4, includes the digital content, DRM information and payment information for the digital content, to facilitate and simplify the payment for the digital content. In one embodiment, the payment information of the digital content is combined with the DRM information of the digital content. In another embodiment, the payment information of the digital content is embedded into the DRM information of the digital content.

The network system 100 also provides a payment module to receive a payment 122 from a buyer based on the received payment information, and an authorization module, after receiving the payment 122, to allow the buyer to play the digital content under restrictions by the received DRM information. In an embodiment, the network system 100 further provides a notification module to notify the buyer of allowance to play the received digital content. In an embodiment, the payment module, authorization module, and notification module may reside in the payment system 112 as shown in detail in FIG. 6.

The DRM information and payment information for the digital content may be included in a header of the digital content.

In some embodiments, the first buyer system 114 may provide a website working as a virtual jukebox (not shown). The virtual jukebox can be used by a user of the first buyer system 114 to post or advertise a list of digital songs originally received from one or more seller systems such as the seller system 110. The user of the virtual jukebox is allowed to play or listen to a song selected from the list of digital songs after making a payment of a predetermined amount of money (e.g., $0.10). In some embodiments, the payment of the predetermined amount of money is made by pressing a select button near the chosen song, or simply by pressing a linking title of the chosen song. In some embodiments, the virtual jukebox includes integrated payment information and DRM information for the listed digital songs. The payment information may be either combined with, or embedded into the DRM information of the digital song. The payment information may, for example, inform the user of the predetermined amount of money for playing or listening to each of the listed songs. The DRM information may, for example, include the number of times the selected song may be played. In some embodiments, the DRM information permits the selected song to be played only a single time, thus creates a virtual jukebox, in which a selected song is played once after a payment is made.

Interface

FIG. 2 illustrates a diagram showing an interface 200 for a buyer to receive a digital content according to an example embodiment. The interface 200 can be used by the buyer to receive a digital content package 120, which is distributed either from the seller system 110 or from another buyer via the network 118. The interface 200 can also be used by the buyer to transmit a payment for the digital content to the payment system 112 via the network 118, which facilitates the payment process of the digital content. The interface 200 includes a digital content portion 210 for the digital content and a header portion 212. The header portion 212 provides DRM information 214 and payment information 216 of the received digital content. In this embodiment, the payment information 216 is combined with the DRM information 214.

FIG. 3 illustrates a diagram showing an interface 300 for a buyer to receive the digital content according to another example embodiment. Like the interface 200 shown in FIG. 2, the interface 300 includes a digital content portion 310 for the digital content and a header portion 312. The header portion 312 provides DRM information 314 and payment information 316 of the received digital content. In this embodiment, the payment information 316 is embedded into the DRM information 314. However, the arrangement of the DRM information and payment information of the digital content is not limited to those ways shown in FIGS. 2 and 3, and the DRM information can be arranged in other ways to associate it with the payment information of the digital content so as to facilitate the payment process for the digital content.

Data Structure

FIG. 4 illustrates a diagram showing a data structure 400 of a distributed digital content package 120 according to an example embodiment. The data structure 400 of the distributed digital content package 120 can be stored on a computer-readable medium and has three fields for containing data. A first field contains data representing digital content 410, which is distributed to a buyer from either a seller or another buyer over a network 118. A second field contains data representing DRM information 414 of the distributed digital content 410 in the first field. A third field contains data representing payment information 416 of the distributed digital content 410 in the first field.

Buyer System

FIG. 5 illustrates a block diagram showing a buyer system 500 according to an example embodiment. The buyer system 500 provides an interface (as shown in FIGS. 2 and 3) for a buyer to receive a digital content package 120 either from a seller system 110 or from another buyer, in which the digital content package 120 may include the digital content, DRM information and payment information for the digital content. The payment information can be either combined with the DRM information or embedded into the DRM information, and can also be associated with the DRM information in other known ways to facilitate the payment process of the digital content.

The buyer system 500 may include a digital content storage 510 accessible to the buyer to store the received digital content package 120. The buyer system 500 may also include a preview module 512 to allow the buyer to preview the received digital content using a media player 514, for example, for a predetermined number of times (such as 3 times for a track of music) or for a predetermined length of time (such as 10 minutes for a movie). Other known preview ways can also be used. The buyer system 500 may further include a payment transmission module 516, which can be used by the buyer, if determined to buy the digital content, to transmit a payment for the digital content to the payment system 112 via the network 118 based on the received payment information (like 216, 316).

Payment System

FIG. 6 illustrates a block diagram showing a payment system 600 for processing payments according to an example embodiment. The payment system 600 may include a payment module 610, an authorization module 612, and a notification module 614. The payment module 610 may receive a payment 122 from a buyer for digital content. The payment is based on the payment information (such as 216, 316) of the digital content, which has been received by the buyer in a digital content package 120 along with the digital content and the DRM information of the digital content. After receiving the payment 122, the authorization module 612 may allow the buyer to play the digital content 410 under restrictions described in the distributed DRM information for the digital content.

Methods of Distributing Digital Content

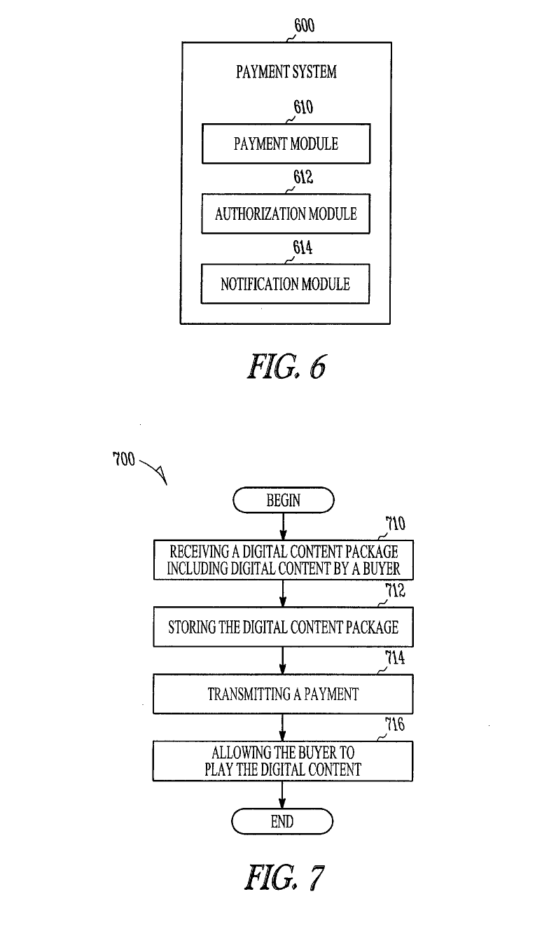

FIG. 7 illustrates a high level flowchart showing a method 700 of distributing digital content (e.g., digital music, digital videos, digital documents, and digital photos) from a first buyer to a second buyer via a peer-to-peer network according to an example embodiment.

At 710 of the embodiment, the second buyer receives a digital content package 120 from the first buyer. The digital content package 120 includes the digital content (e.g., 210, 310) and its header (e.g., 212, 312), and the header includes DRM information (e.g., 214, 314) and payment information (e.g., 216, 316) of the digital content. In one embodiment, the payment information is combined with the DRM information. In another embodiment, the payment information is embedded into the DRM information.

At 712, the second buyer may store the digital content package 120 in a digital content storage 510, which is accessible to the second buyer.

At 714, if determined to buy the digital content, the second buyer may transmit a payment 122 to the payment system 112 based on the received payment information.

At 716, after receiving the payment 122, the payment module 610 of the payment system 600 may allow the second buyer to play the digital content under restrictions described in the received DRM.

Before transmitting the payment 122 at step 714, the preview module 512 may permit the second buyer to preview the received digital content to help the second buyer determine whether or not to buy the digital content. In one embodiment, the second buyer is permitted to preview the received digital content (such as digital music) for a predetermined number of times (such as 3 times) with no charge. In another embodiment, the second buyer is permitted to preview the received digital content (such as a digital movie) for a predetermined length of time (such as 10 minutes) with no charge.

After allowing the second buyer to play the digital content at step 716, the notification module 614 of the payment system 600 may notify the second buyer of the allowance to play the received digital content. The notification module 614 may send the notification in many ways, such as by e-mails or e-messages via the network.

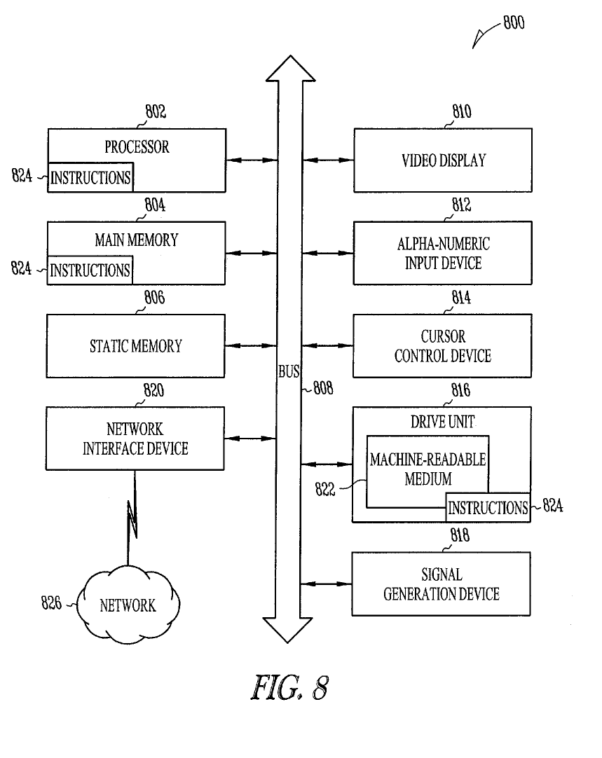

FIG. 8 illustrates a block diagram showing a machine in the example form of a computer system, within which a set of sequence of instructions for causing the machine to perform any one of the methodologies discussed herein may be executed. In alternative embodiments, the machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions that specify actions to be taken by that machine. Further, while only a single machine is illustrated, the term “machine” shall also be taken to include any collection of machines that individually or jointly execute a set of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alpha-numeric input device 812 (e.g., a keyboard), a cursor control device 814 (e.g., a mouse), a disk drive unit 816, a signal generation device 818 (e.g., a speaker) and a network interface device 820.

The disk drive unit 816 includes a machine-readable medium 822 on which is stored one or more sets of instructions (e.g., software 824) embodying any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media.

The software 824 may further be transmitted or received over a network 826 via the network interface device 820.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Although the present application has been described with reference to specific embodiments, it will be evident that various modifications and changes may be made to these embodiments without departing from the broader spirit and scope of the application Accordingly, the specification and drawings are to be regarded in an illustrative rather than a restrictive sense.

1. A system for a buyer to receive digital content from a party over a network, the system comprising:
an interface to receive from the party a digital content package including the digital content and a header thereof, wherein the header provides Digital Rights Management (DRM) information and payment information for the digital content, wherein the payment information is embedded into the DRM information.

2-3. (canceled)

4. The system of claim 1, further comprising a digital content storage accessible to the buyer to store the digital content package.

5. The system of claim 1, further comprising a preview module to allow the buyer to preview the digital content for a predetermined number of times or for a predetermined length of time.

6. The system of claim 1, wherein the party is another buyer, and the digital content package is distributed from the party to the buyer over a peer-to-peer network.

7. The system of claim 1, wherein the party is a seller.

8. A system to process payments comprising:
a payment module to receive from a buyer a payment for digital content based on payment information of the digital content, wherein the digital content, Digital Rights Management (DRM) information and the payment information of the digital content are distributed in a package from a party to the buyer, and wherein the payment information is embedded into the DRM information; and
an authorization module, after receiving the payment, to allow the buyer to use the digital content under restrictions by the distributed DRM.

9. The system of claim 8, further comprising a notification module to notify the buyer of allowance to use the distributed digital content.

10. The system of claim 8, wherein the party is another buyer, and the package is distributed from the party to the buyer via a peer-to-peer network.

11. A system to distribute digital content from a first party to a second party over a network, the system comprising:
an interface to receive from the first party a digital content package including the digital content and a header thereof, wherein the header provides Digital Rights Management (DRM) information and payment information for the digital content, and wherein the payment information is embedded into the DRM information;
a payment module to receive a payment from the second party based on the received payment information; and
an authorization module, after receiving the payment, to allow the second party to use the digital content under restrictions by the received DRM.

12-13. (canceled)

14. The system of claim 11, further comprising a digital content storage accessible to the second party to store the digital content package.

15. The system of claim 11, further comprising a preview module to allow the second party to preview the digital content for a predetermined number of times.

16. The system of claim 11, further comprising a preview module to allow the second party to preview the digital content for a predetermined length of time.

17. The system of claim 11, further comprising a notification module to notify the second party of allowance to use the received digital content.

18. The system of claim 11, wherein both the first party and the second party are buyers, and the digital content package is distributed from the first party to the second party over a peer-to-peer network.

19-23. (canceled)

24. A method to distribute digital content from a first buyer to a second buyer over a peer-to-peer network, the method comprising:
receiving a digital content package by the second buyer from the first buyer, wherein the digital content package includes the digital content and a header thereof, and the header includes Digital Rights Management (DRM) information and payment information of the digital content, and wherein the payment information is embedded into the DRM information;
storing the digital content package in a digital content storage accessible to the second buyer;
transmitting a payment from the second buyer, if determined, based on the payment information; and
allowing the second buyer to play the digital content under restrictions of the received DRM.

25-26. (canceled)

27. The method of claim 24, further comprising, before transmitting the payment, previewing the digital content by the second buyer for a predetermined number of times.

28. The method of claim 24, further comprising, before transmitting the payment, previewing the digital content by the second buyer for a predetermined length of time.

29. The method of claim 24, further comprising receiving notification by the second buyer of allowance to play the received digital content.

30. A computer-readable medium including instructions that, when performed by a computer in order to distribute digital content from a first buyer to a second buyer over a peer-to-peer network, cause the computer to:
receive a digital content package by the second buyer from the first buyer, wherein the digital content package includes the digital content and a header thereof, and the header includes Digital Rights Management (DRM) information and payment information of the digital content, and wherein the payment information is embedded into the DRM information;
store the digital content package in a digital content storage accessible to the second buyer;
transmit a payment by the second buyer, if determined, based on the received payment information; and
allow the second buyer to play the digital content under restrictions of the received DRM.

31-32. (canceled)

33. The computer-readable medium of claim 30, further comprising instructions that cause the computer, before transmitting the payment, to preview the digital content by the second buyer for a predetermined number of times.

34. The computer-readable medium of claim 30, further comprising instructions that cause the computer, before transmitting the payment, to preview the digital content by the second buyer for a predetermined length of time.

35. The computer-readable medium of claim 30, further comprising instructions that cause the computer to receive notification by the second buyer of allowance to play the received digital content.

36. The system of claim 8, wherein the authorization module, after receiving the payment, will allow the buyer to use the digital content once under the restrictions by the DRM.

37. The computer-readable medium of claim 30, wherein the second buyer is allowed to play the digital content once under restrictions of the received DRM.
